(19) United States
(12) Patent Application Publication
(10) Pub. No.: US 2022/0042372 A1
(43) Pub. Date: Feb. 10, 2022

(54) Motorized Window Covering Having Electronic Port Located at Bottom Rail and Power Storage Device Located at Upper Rail

(71) Applicant: Hunter Douglas, Inc., Pearl River, NY (US)

(72) Inventors: Marcelo ALVES, Buford, GA (US); Max GROOM, Buford, GA (US); Bill WHYTE, Buford, GA (US)

(21) Appl. No.: 16/986,199

(22) Filed: Aug. 5, 2020

(51) Int. Cl. E06B 9/322; E06B 9/68; E06B 9/262

(52) U.S. Cl. CPC E06B 9/322; E06B 2009/2435; E06B 9/262; E06B 9/68

(57) ABSTRACT

A motorized window covering assembly including a head rail, a bottom rail, and a window covering extending therebetween. Located at the head rail is a power storage device, while an electronic port (e.g., transferring power and/or data) is located at the opposite bottom rail. Electrical conductors are routed through the window covering electrically connecting the power storage device to the electronic port. The power storage device is chargeable at any position of the bottom rail relative to the head rail.

### BACKGROUND OF THE INVENTION

### Field of the Invention

The present invention relates to a motorized window covering for any environment, home, business, office, or otherwise. More particularly, the invention relates to an improved motorized window covering in which an electronic port (e.g., transferring power (charging) and/or data) is located at a bottom or lower rail, while a power storage device (e.g., battery) is located at an upper or head rail.

### Description of Related Art

Window coverings such as shades or blinds (e.g., a roller shade, a Roman shade, a honeycomb/cellular/accordion shade, a pleated shade, a venetian blind, a slatted blind, etc.) provide privacy and limit the amount of sun, if any, entering through a window. Originally, such window coverings were deployed (advanced upwards/downwards and/or tilted or adjusted to a desired angle) by the user manipulating by hand a cord, string, adjustment wand or other known mechanical device. With current technological advancement motorized window coverings eliminate the need for hand manipulation by the user. Motorization provides certain advantages over that of conventional manual hand manipulation. Adjustment of the window covering is possible despite its location in the building (e.g., too high or difficult to reach with furniture/structures obstructing access). Not just convenience, safety is also improved with the use of motorized window coverings by eliminating having to stand on a ladder, stool or a nearest available chair. In addition, motorization allows for programmable adjustment of the window covering, as desired, based on various conditions, for example, time of day or extent of sun detected entering the window.

Conventional motorized window covering assemblies often include an electronic port (e.g., a charging port and/or a data port) housed in the head rail which poses several problems. Placement of the electronic port at such elevated height relative to the floor is inconvenient for connecting a power cable from the electrical wall socket to the electronic port. A step ladder, chair, or stool may be necessary to reach the height of the head rail of a household window at a typical height. Positioning of the household window at a greater height requires a very tall ladder posing an even greater safety risk, assuming that the homeowner owns, rents, or is able to borrow a ladder at substantial cost, weight to carry, and space to store. Furthermore, running the power cable from the electronic port housed at the head rail down the length of the window is unappealing aesthetically and the substantial slack in the power cable poses a safety risk (possibly failing to meet strict safety regulations).

It is therefore desirable to develop an improved motorized window covering including: (i) an electronic port (e.g., a charging port transferring power and/or a data port transferring data) located at a bottom or lower rail; (ii) a power storage device (e.g., battery) located at a head or upper rail; (iii) electrical conductor(s) routed between the head and bottom rails; wherein the power storage device is rechargeable irrespective of the position of the bottom rail relative to the head rail.

### SUMMARY OF THE INVENTION

An aspect of the present invention is an improved motorized window covering including: (i) an electronic port located at a bottom rail; (ii) a power storage device located at a head rail; (iii) an electrical conductor extending between the head and bottom rails; wherein the power storage device is chargeable irrespective of the position of the bottom rail relative to the head rail.

Another aspect of the present invention is directed to a motorized window covering assembly including a head rail, a bottom rail, and a window covering extending therebetween. Located at the head rail is a power storage device, while an electronic port is located at the opposite bottom rail. Electrical conductors are routed through the window covering electrically connecting the power storage device to the electronic port. The power storage device is chargeable at any position of the bottom rail relative to the head rail.

Still another aspect of the present invention relates to a method for operating a motorized window covering assembly, as described in the preceding paragraph, wherein the power storage device is chargeable at any position of the bottom rail relative to the head rail.

### BRIEF DESCRIPTION OF THE DRAWING

The foregoing and other features of the present invention will be more readily apparent from the following detailed description and drawings of illustrative embodiments of the invention wherein like reference numbers refer to similar elements throughout the several views and in which:

FIG. 1 is a perspective front view of the present inventive motorized window covering assembly with the window covering is in a lowered position;

FIG. 2 is an enlarged view of section II of the bottom rail in FIG. 1 depicting a power cable having a barrel plug connector plugged into the electronic port;

FIG. 3 is an internal view of the head rail of FIG. 1 from the front of the assembly (facing outward away from the window), showing electrical and mechanical components housed therein;

FIG. 4 is an internal view of the head rail of FIG. 1 from the rear of the assembly (facing inwards towards the window), showing electrical and mechanical components housed therein;

FIG. 5 is a side perspective view of the slip ring, axle rod and electrical conductor coils wound about the lifting spools all housed within the head rail of FIG. 1;

FIG. 6A is enlarged end perspective view of the electrical conductors connected to the slip ring in FIG. 5;

FIG. 6B is an enlarged opposite end perspective view of the electrical conductor coil electrically connected to the slip ring in FIG. 5;

FIG. 7A is an enlarged end view of the electronic port incorporated into a molded end cap of the bottom rail;

FIG. 7B is an enlarged view of the electronic port in section VII(B) of FIG. 7A;

FIG. 7C is an exploded view of an exemplary bottom rail of the present inventive motorized window covering assembly with two lifting cords each having an associated conductor wire twisted/braided therewith;

FIG. 7D illustrates a perspective view of an exemplary bottom rail of the present inventive motorized window covering and the securing of two separate lifting cords therethrough using a locking ferrule;

FIG. 8 depicts a rear view (facing towards the window being covered) of a particular embodiment of the present inventive motorized window covering assembly with a plurality of photovoltaic cells mounted to the bottom rail facing towards the window for charging of the power storage device housed in the head rail;

FIG. 9A is a perspective rear view of the window covering in a lowered position showing the photovoltaic cells mounted to the bottom rail at an angle facing upwards towards the top of the window, wherein the photovoltaic cells are electrically connected via a power cable to the electronic port incorporated into the end cap of the bottom rail;

FIG. 9B is an enlarged view of section XI(B) in FIG. 9A;

FIG. 10A is a perspective view of an exemplary channel mounting device for releasably detaching the photo voltaic cells to the bottom rail; the channel mounting device includes a first section and a second section integral with and arranged at an acute angle relative to the first section; wherein the bottom rail and the photo voltaic cells are slid/clipped/snapped into the respective first and second sections of the channel mounting device;

FIG. 10B is an end view of the channel mounting device of FIG. 10A;

FIG. 10C is a perspective view of another exemplary channel mounting device for releasably detaching the photo voltaic cells to the bottom rail; the channel mounting device includes a first section and a second section integral with and arranged perpendicular relative to the first section; wherein the bottom rail and the photo voltaic cells are slid/clipped/snapped into the respective first and second sections of the channel mounting device;

FIG. 10D is an end view of the channel mounting device of FIG. 10C;

FIG. 10E is a perspective rear view of an exemplary bracket mounting device for releasably detaching the photo voltaic cells to the bottom rail, wherein the bracket mounting device includes a first section and a second section integral with and arranged at an acute angle relative to the first section; wherein the first and second sections of the bracket mounting device are clipped on to the bottom rail and the photo voltaic cells, respectively;

FIG. 10 F is a perspective end view of the bottom rail (with the endcap removed) illustrating the bracket mounting device of FIG. 10E with the bottom rail and photo voltaic cells secured in the respective first and second sections (the window covering not being illustrated so that the conductor wires and lifting cord are clearly visible);

FIG. 11A is a perspective view of the exemplary bracket mounting device for releasably detaching the photo voltaic cells to the bottom rail of FIG. 10E modified to include a counterweight disposed externally of the first section for opposing/balancing the weight of the photo voltaic cells;

FIG. 11B is an end view of the bracket mounting device with counterweight of FIG. 11A;

FIG. 12 is a rear view of an exemplary arrangement of electrical and mechanical components housed within the head rail including two lifting spools and associated slip rings with the axle rod passing through all four components; the electrical conductors extending between the head and bottom rails being separated wherein each electrical conductor is twisted/braided with an associated lifting cord;

FIG. 13A is a rear view an exemplary configuration with the power storage device housed internally within the head rail at a terminating end of the axle rod (may alternatively be positioned at the opposite terminating end of the axle rod or anywhere between the lifting spools); wherein the bottom rail is depicted in a lowered position and the window covering is not shown so that the lifting cord and braided conductor wires running therethrough are clearly visible;

FIG. 13B is a front view of yet another exemplary configuration of the power storage device mounted externally to the housing of the head rail; and

FIG. 13C is a rear view of the head rail with externally mounted power storage device of FIG. 13B;

FIG. 13D is a front view of still another exemplary configuration of the power storage device mounted to the window trim of the window to be covered at a position substantially aligned with the head rail when mounted to the window trim;

FIG. 14A depicts the mechanical and electrical internal components (without showing the head rail, bottom rail, or window covering) of the present inventive motorized window covering to illustrate the design employing a single lifting cord separate from the conductor wires braided together;

FIG. 14B depicts the mechanical and electrical internal components (without showing the head rail, bottom rail, or window covering) of the present inventive motorized window covering to illustrate an alternative design employing separated conductor wires and two lifting cords, wherein each conductor wire is twisted/braided with an associated lifting cord;

FIG. 15 is a partial perspective view of the bottom rail illustrative of the exemplary wiring of the conductor wires emerging from the window covering (not shown) and running internally through the bottom rail to the electronic port; and

FIG. 16 is a partial perspective view of the head rail illustrative of the exemplary wiring of the conductor wires running internally through the head rail and entering the window covering (not shown).

### DETAILED DESCRIPTION OF THE INVENTION

By way of illustrative example only, the present invention is shown and described as a motorized accordion shade window covering. It is contemplated and within the scope of the present invention for the motorization in accordance with the present invention to be employed with any type of window covering such as shades or blinds, including, but not limited to: a roller shade, a Roman shade, a honeycomb/cellular/accordion shade, a pleated shade, a venetian blind, a slatted blind, etc. The front of the window covering faces away from the window that is being covered, whereas the rear of the window covering faces toward the window being covered.

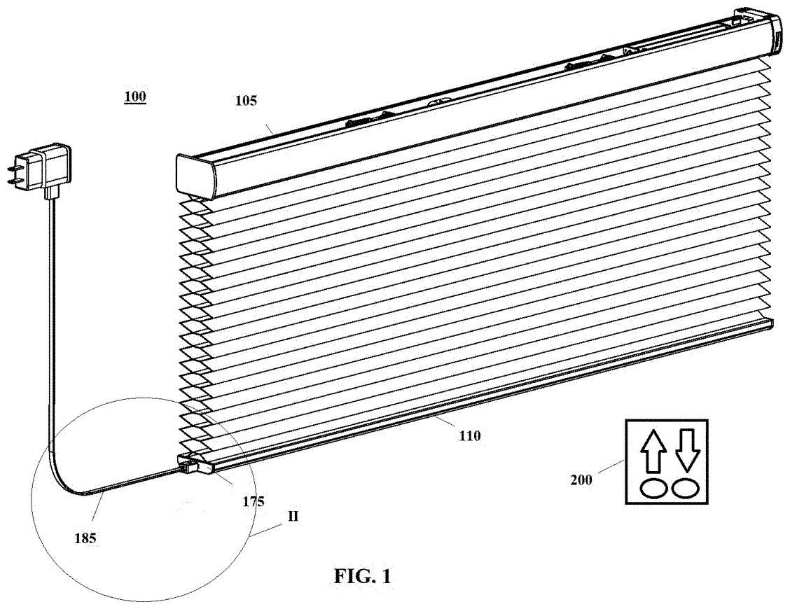

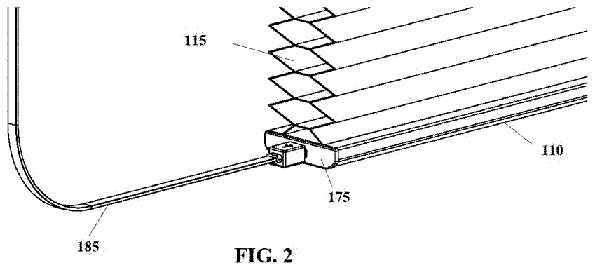

Referring to FIG. 1, the present inventive motorized window covering assembly 100 includes a head or upper rail 105, a bottom or lower rail 110, and a window covering 115 (shown for illustrative purposes as a cellular/honeycomb/accordion shade, but any type of window covering may be used) extending therebetween. Housed in the head rail 105 are the mechanical and electrical components to raise and lower the window covering 115 at any desired position.

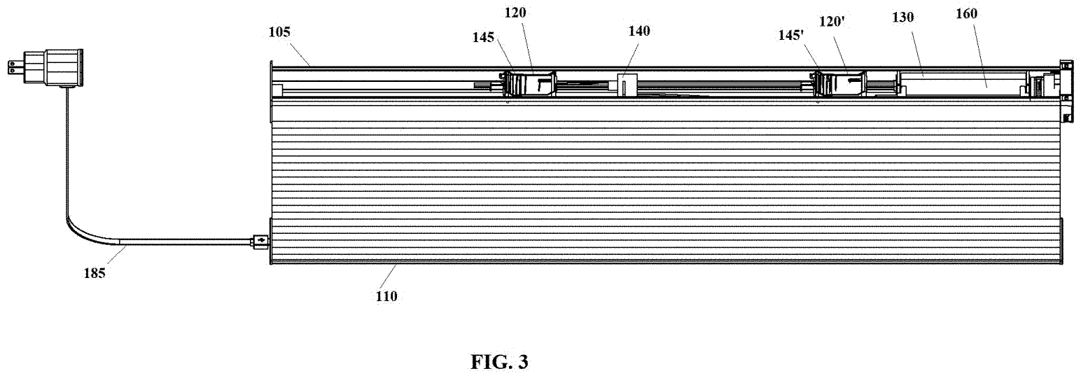

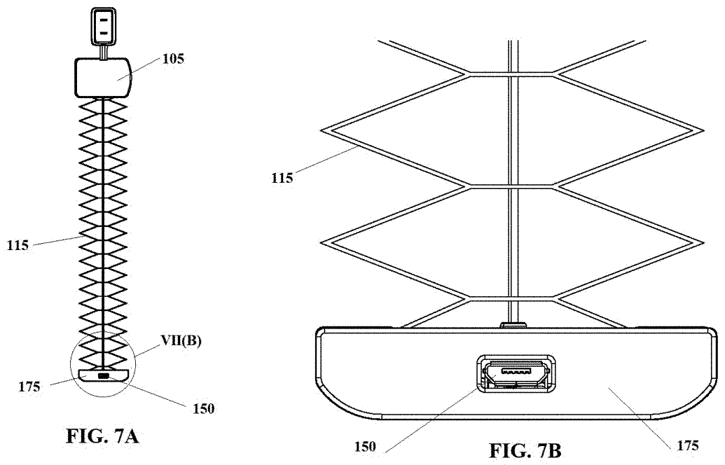

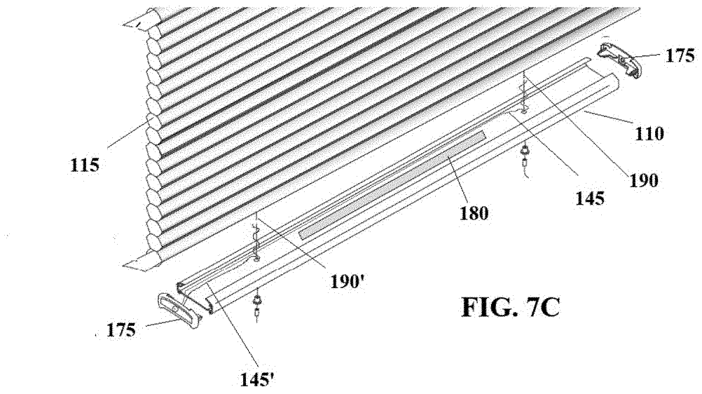

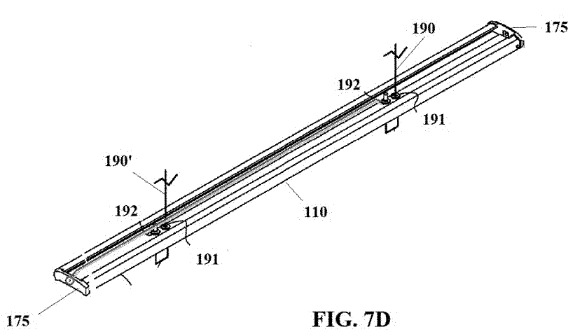

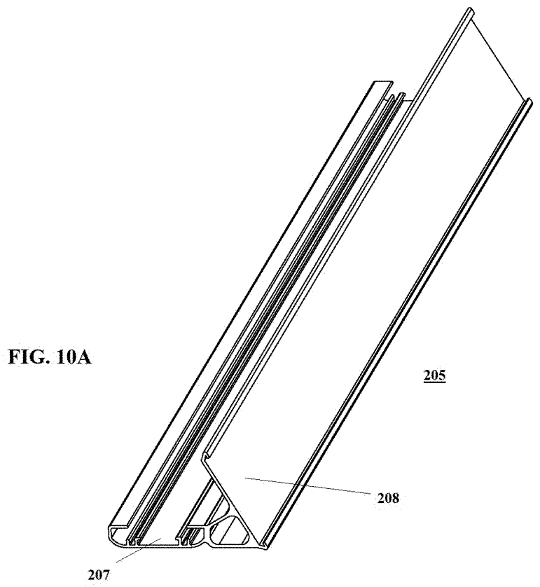

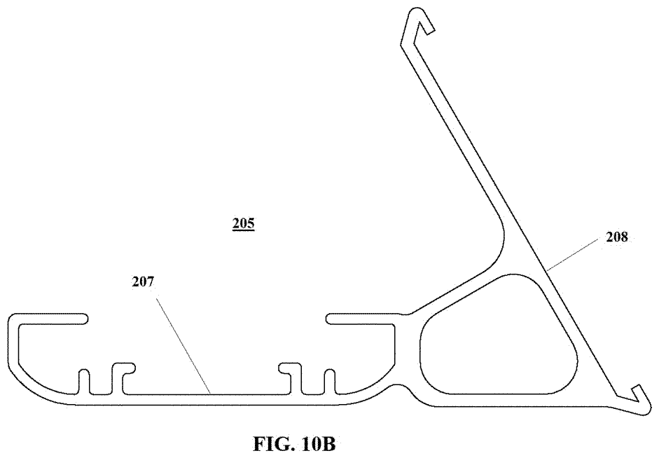

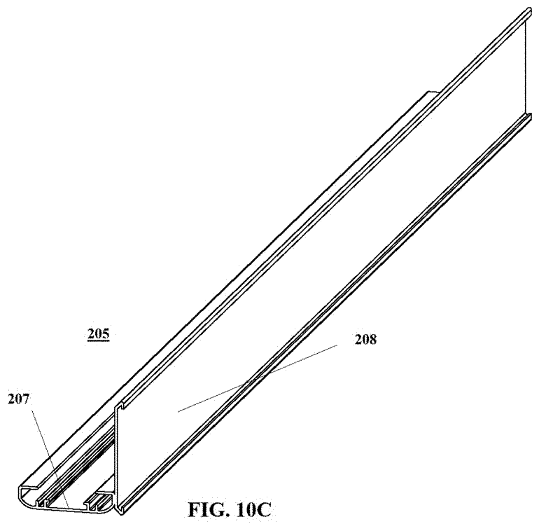

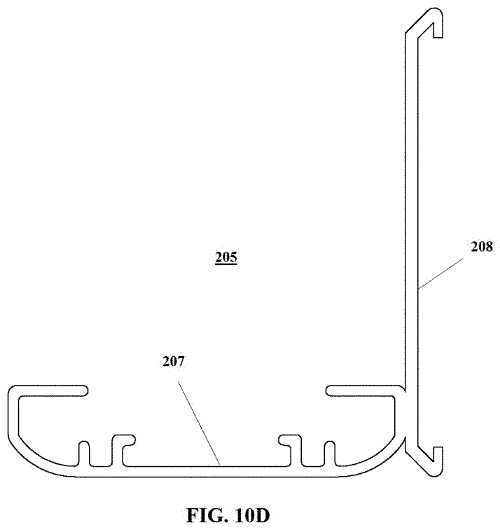

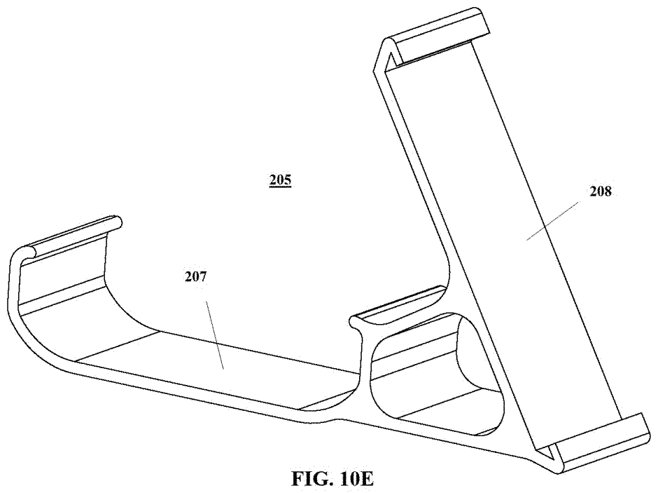

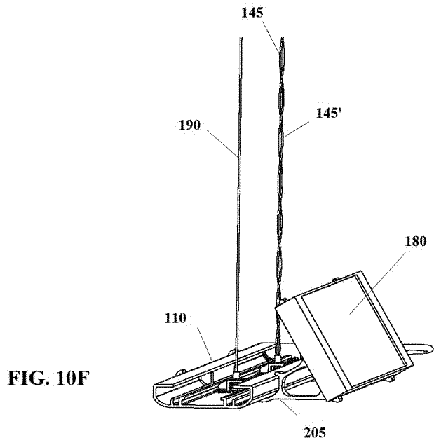

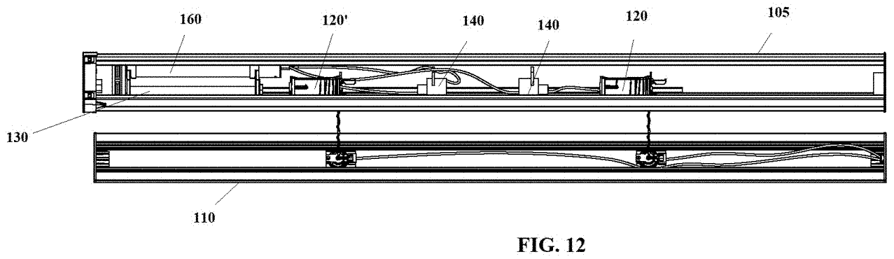

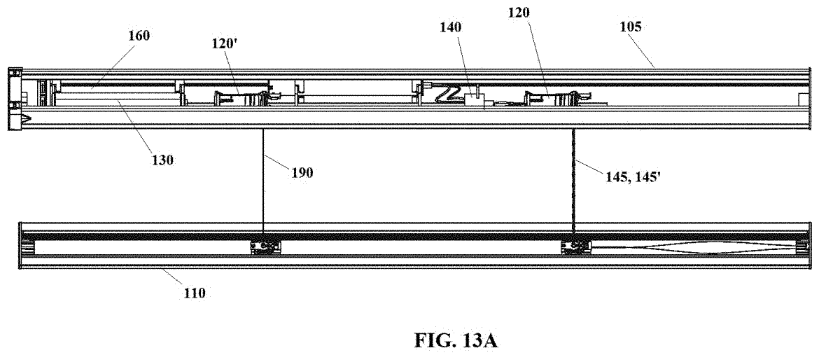

Referring to the exemplary configuration depicted in FIGS. 3 & 4, the internal mechanical and electrical components housed in the head rail 105 include: lifting spools 120, 120′; a motor 130 (comprising a stationary stator and a rotating rotor); and a power storage device (e.g., rechargeable battery) 160. Any number of two or more lifting spools may be employed, as desired, that serve multi-purpose functionality of: supporting the weight of the window covering; adjusting the position of the window covering; and spooling the lifting cords and electrical conductors. Electrical conductors 145, 145′ (e.g., electrical cable, electrical wire, electrical coil, metallic strips, or metallic tape) are taken-up by winding (as described in further detail below) about the respective lifting spool 120, 120′ with the raising of the window covering. In this exemplary design, each electrical conductor 145, 145′ is spooled together (sheathed, twisted or braided together) with a corresponding lifting cord 190, 190′, as depicted in FIGS. 7C, 12 & 14B. Alternatively, the window covering may be raised/lowered via a single lifting cord 190, wherein the two electrical conductors 145, 145′ are braided/twisted and taken-up together about a corresponding lifting spool 120, while the single lifting cord 190 is taken-up about another lifting spool 120′, as shown in FIGS. 10F, 13A-13C, 14A. Energized by the power storage device 160, motor 130 causes the axle rod 135 together with the lifting spools 120, 120′ supported thereon to rotate raising the position of the window covering 115 as the lifting cord(s) 190, 190′ are wound about the lifting spools 120, 120′ while the slack in the electrical conductor(s) 145, 145′ is wound about the lifting spool(s) 120, 120′.

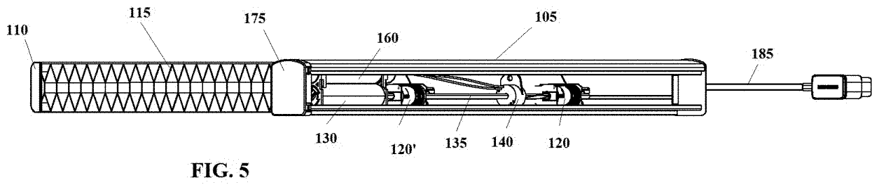

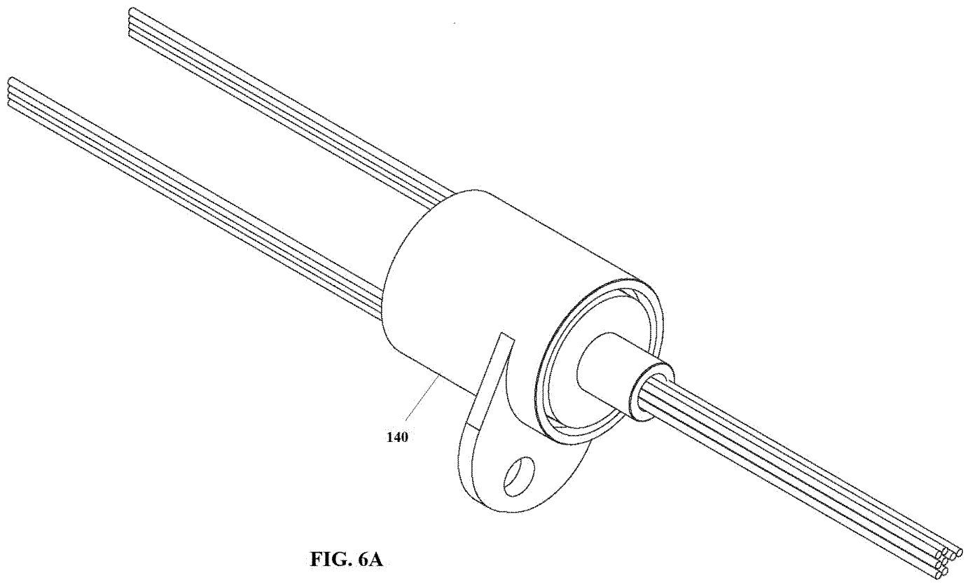

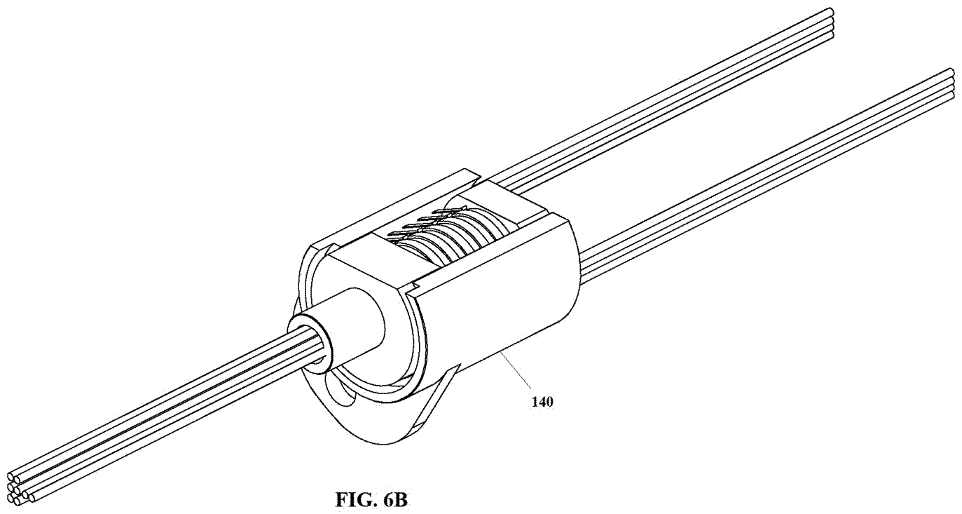

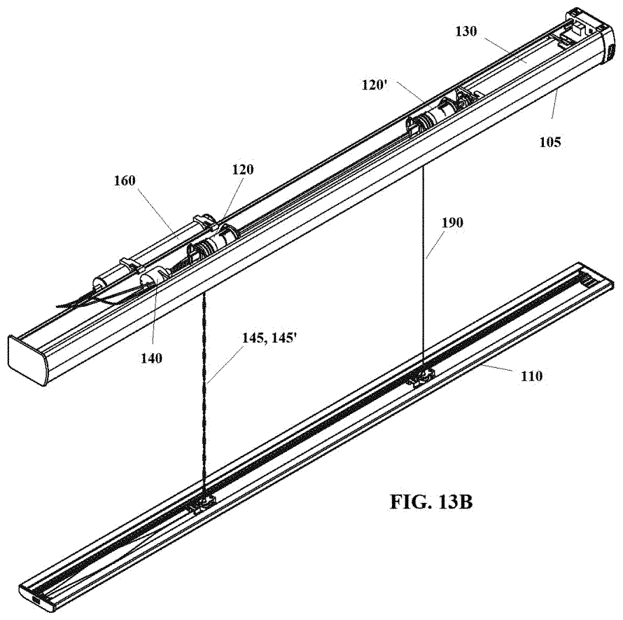

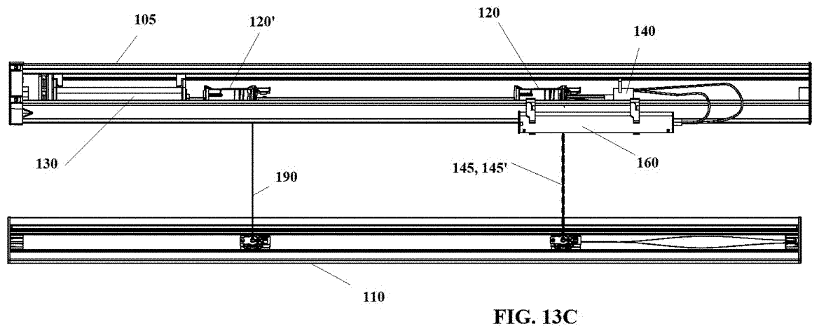

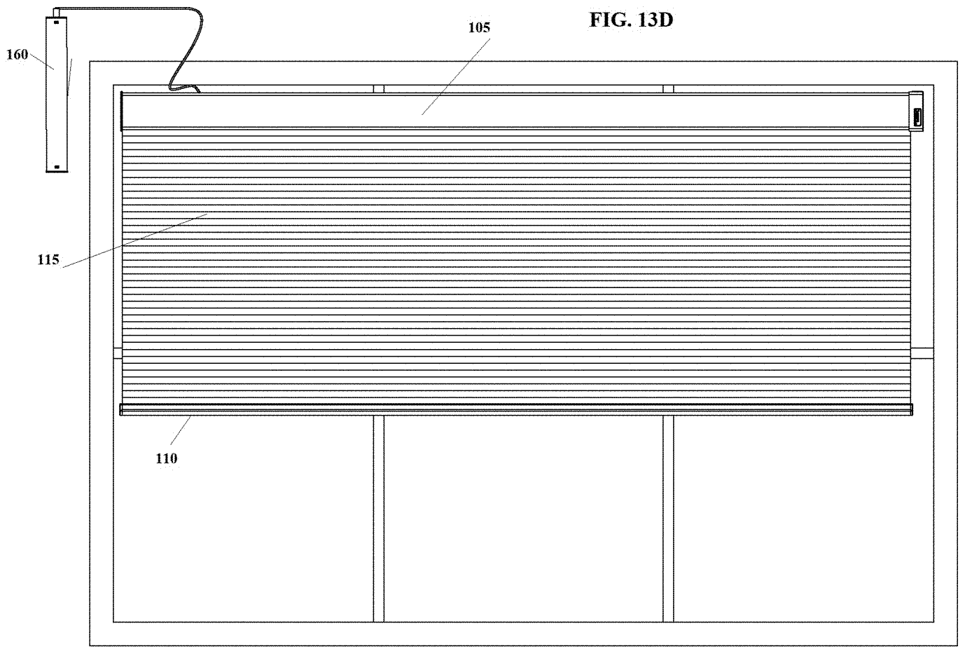

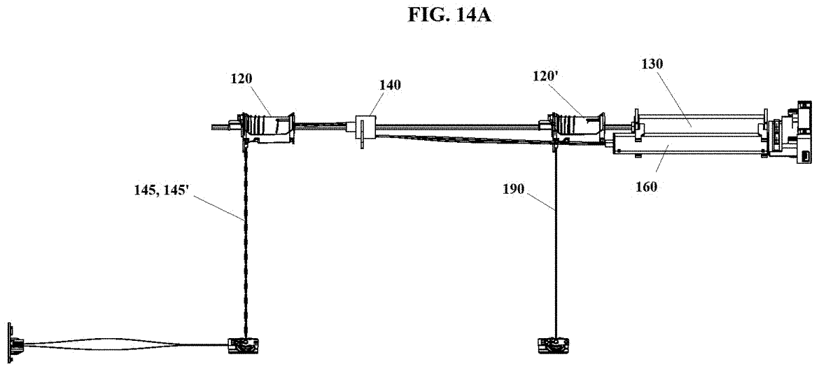

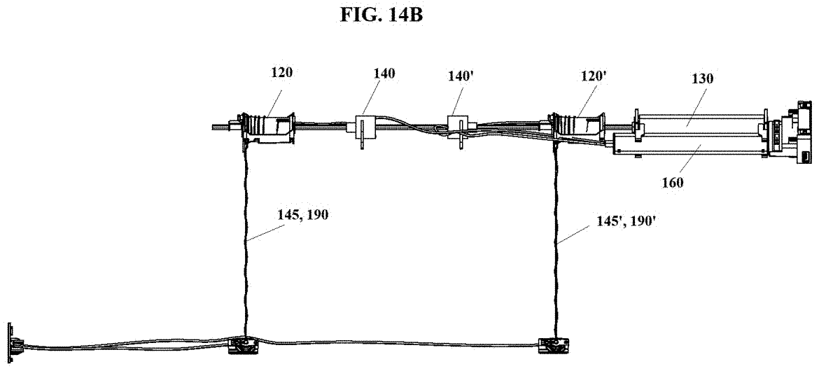

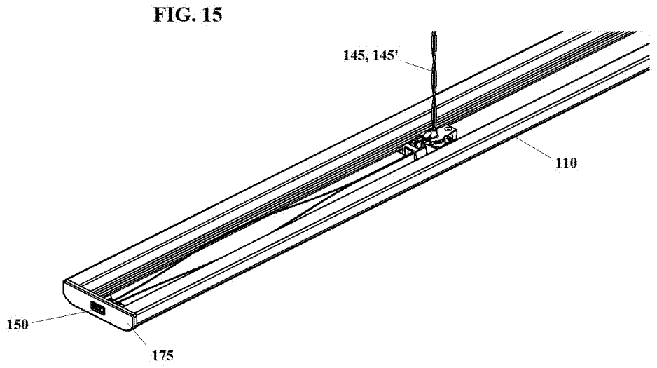

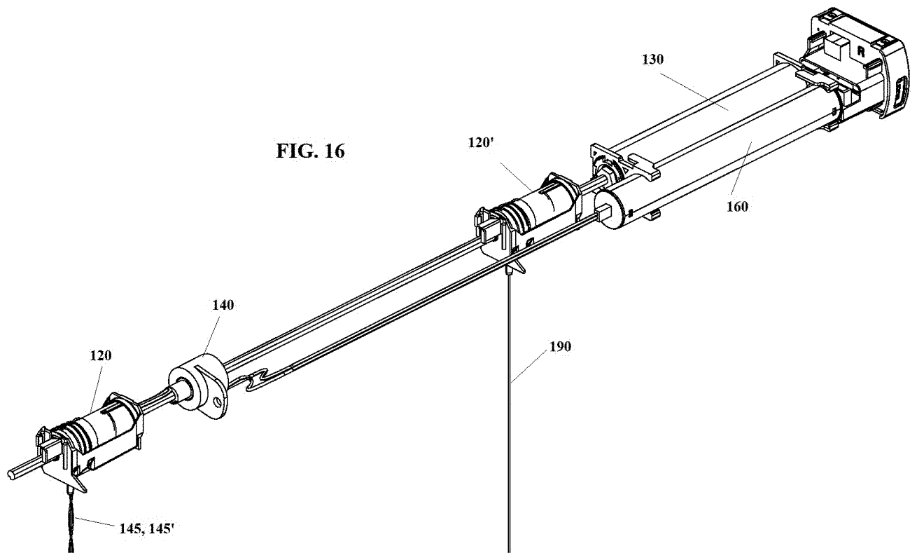

The electrical and mechanical components housed in the head rail 105 starting from one end of the axle rod 135 and traversing to the opposite end will now be described in further detail. In the exemplary configuration shown in FIGS. 5, 14A & 16, a slip ring 140 having a through hole is supported on the axle rod 135 between the two lifting spools 120, 120′. An alternative arrangement in FIGS. 13B & 13C depicts the slip ring 140 mounted to a terminating free end (either free end) of the axle rod 135 extending beyond the lifting spool 120. More than one slip ring 140, 140′ each associated with a corresponding lifting spool 120, 120′ is contemplated and shown in FIG. 14B. The slip ring conducts the electronic signal from the rotating rotor to the stationary stator. Electrically connected to the motor 130, slip ring 140 has rotating a component with an electronic sensor that rotates about a stationary base. FIGS. 6A & 6B depict enlarged views of the electrical conductors electrically connected to the slip ring. During operation, the rotating component of the slip ring rotates with that of the axle rod 135, while the stationary component of the slip ring is maintained stationary or in place by the electrical conductors electrically connected to the bottom rail. Axle rod 135 extends axially through the lifting spools 120, 120′. The electrical conductors 145, 145′ are taken-up by winding about the respective lifting spools 120, 120′ rotated by the motor 130. Electrical conductors 145, 145′ preferably terminate at the lifting spool 120, 120′ with a knot secured within a locking groove or slot. Motor 130 mounted to the axle rod 135 is powered by the power storage device 160 (e.g., rechargeable battery).

The electrical conductors 145, 145′, carrying electricity/electronic data/electronic communications, are routed between the head and bottom rails 105, 110, respectively, through the window covering 115. The type of electrical conductors employed typically depends on the type of window covering. For instance, in the case of a roller shade, preferably metallic strips or metallic tape of minimal thickness is sandwiched between two layers of material or fabric secured together. Whereas, the electrical conductors are preferably electrical cable or electrical wires in window coverings where thickness (diameter) is less of a concern, such as wherein the electrical conductor is: (i) woven in-and-out through the slats of the blind (e.g., slatted or venetian); or (ii) sandwiched between cells formed between adjacent layers of material forming the shade (e.g., accordion or cellular shade).

The electrical conductors, cables or wires 145, 145′ extending through the window covering 115 between the head and bottom rails 105, 110, respectively, may be routed via an independent path separate from that of the lift cord 190 assembly (as shown in FIGS. 10F, 13A-13C & 14A), requiring its own associated hardware. For aesthetic purposes each of the electrical conductors, cables or wires 145, 145′ may instead be camouflaged by incorporating (e.g., sheathing, twisting or braiding) into an associated lifting cord 190, 190; along a single common path, as shown in FIGS. 7C, 12 & 14B. Lastly, the electrical cables or electrical wires may also serve as the lifting cord, thereby eliminating altogether the need for a lifting cord and associated hardware.

FIGS. 10F, 13-13C &14A show an embodiment in which two electrical wires 145, 145′ are incorporated (e.g., twisted, braided) and together taken-up (wound) about a single lifting spool 120, while the lifting cord 190 is taken-up (wound) about another lifting spool 120′ as the window covering 115 is raised. Whereas FIGS. 7C, 12 & 14B show positional adjustment of the window covering via two lifting spools 120, 120′ and a split electrical conductor design. Each of the split electrical wires 145, 145′ is incorporated (e.g., sheathed, twisted, braided) with a respective lifting cord 190, 190′ that together is taken-up (wound) about a respective lifting spool 120, 120′ housed in the head rail 105. The design of the motorized window covering may be adapted for using any number of two or more lifting spools. Routing of the electrical conductor(s) between the head and bottom rails need not be incorporated into the lifting cord(s) when aesthetic appearance is of no or minimal concern. Furthermore, the electrical conductors themselves may serve as the lifting cord, thereby eliminating the need for a lifting cord and associated hardware altogether.

The electrical conductors 145, 145′ exiting from the bottom of the window covering are routed through the housing of the bottom rail 110, as shown in FIGS. 7C & 15. To prevent unwanted movement during normal operation, the electrical conductors 145, 145′ in the bottom rail 110 may pass through a strain relief device before being electrically connected to the electronic port 150, as shown in FIG. 7D. Referring to the exploded view in FIG. 7C, the electrical conductors 145, 145′, preferably woven, twisted or braided with the associated lifting cords 190, 190′ after passing through the bottom of the window covering, follow the top face of the bottom rail (hidden from view by the fabric of the window covering) to the end cap 175. Referring to the internal view of the bottom rail 110 in FIG. 7D, lifting cords 190, 190′ and/or electrical conductors 145, 145′ preferably engage a conventional leveling device 191 before being received through a hole in the bottom rail and, after being threaded back via a separate adjacent hole, engage with a locking ferrule 192 before terminating internally within the bottom rail 110. The electrical conductors 145, 145′ are inconspicuously routed between the bottom rail 110 and window covering 115 fabric prior to being electrically connected to the electronic port (e.g., transferring power (charging) and/or data) 150 integrally incorporated in the endcap 175. Routing of the electrical conductors may vary depending on the end user, i.e., to the left or right of the lifting cord.

Charging the power storage device 160 via the electronic port 150 is possible irrespective of the position of the bottom rail 110 relative to that of the head rail 105 (i.e., charging of the power storage device is possible at any position of the window covering). Since the electronic port 150 is housed in the bottom rail (FIGS. 7A & 7B) it is easily accessible to the user when the bottom rail 110 or window covering 115 is in a fully or partially lowered position. As a safety precaution, while charging the power storage device, the bottom rail 110 preferably remains stationary in position to avoid a potentially hazardous safety risk or physical damage to the window covering system (e.g., charging equipment, power outlet) as a result of a change in the position of the bottom rail while plugged into the wall outlet.

In one exemplary configuration illustrated in FIGS. 1 & 2, charging of the power storage device 160 (e.g., rechargeable battery)) for the motorized window covering may be accomplished using an electrical power cable 185 having a plug at respective ends for plugging one end into a DC power source (e.g., electrical power outlet or electrical socket typically located in the wall of a building) and the opposite end (e.g., barrel connector plug) plugged into the electronic port 150 (shown in FIGS. 7A & 7B integral with the end cap 175 of the bottom rail 110). Any type of conventional electronic port is possible such as, but not limited to, a USB port, barrel plug connector, etc. End cap 175 preferably includes a mechanical securing mechanism to retain the complementary plug component of the power cable 185 engaged with the electronic port 150 in the end cap 175. For example, a snap-in, circle clips, threaded hole or pass through hole and nut, or any other conventional mechanical securing device may be utilized.

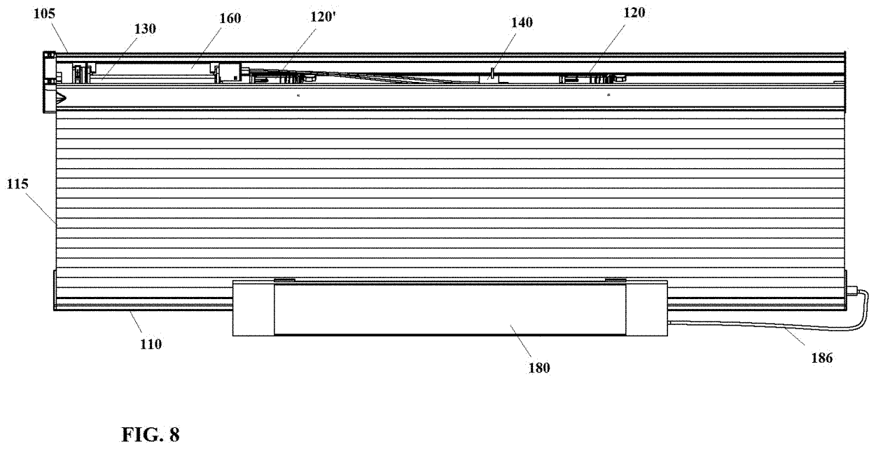

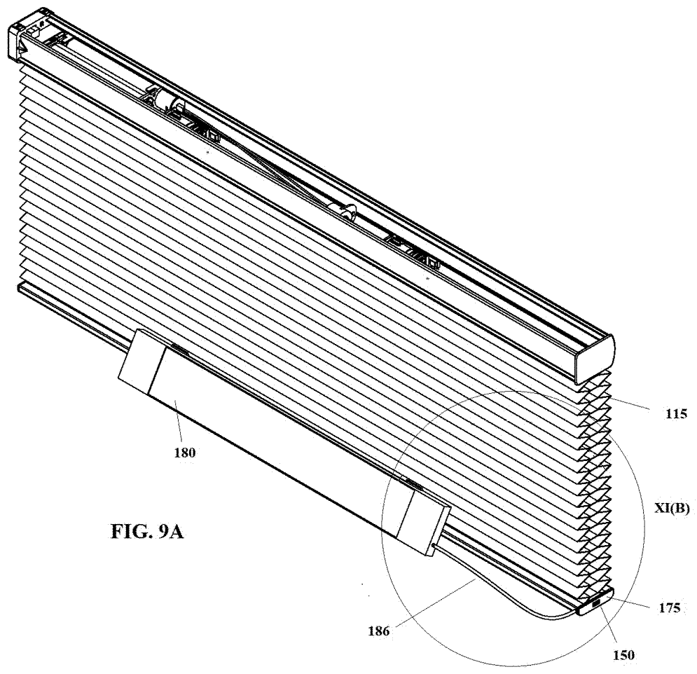

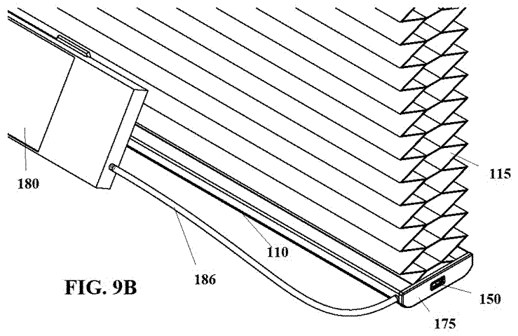

As an alternative to or preferably complementary to that of the presence of the plug-in electrical power cable 185, solar charging of the power storage device 160 (e.g., rechargeable battery) for the motorized window covering may be accomplished by releasably or detachably mounting photo voltaic cells 180 on the bottom rail 110. Referring to FIG. 8, photo voltaic cells 180 are preferably releasably or detachably mounted to the rear/outdoors-facing side (e.g., towards the window being covered) of the motorized window covering. The electrical conductors 145, 145′ routed through the window covering 115 and into the bottom rail 110 are electrically connected to the electronic port 150. FIGS. 9A & 9B show the photo voltaic cells 180 electrically connected to the electronic port 150 of the bottom rail 110 via a dedicated electrical power cable 186. Such electrical connection between the photo voltaic cells and the electronic port may be permanent (e.g., soldered) or releasable (e.g., a barrel plug connector or a pass-through barrel connector that sits substantially flush with the end cap when connected).

The photo voltaic cells 180 are attached to the rear/outward-facing surface (facing towards the window) of the bottom rail 110 using a releasably detachable mounting device 205 for which several different configurations are possible. Regardless of the specific configuration, the releasably detachable mounting device includes a first section 207 receiving therein the bottom rail 110 and a second section 208 receiving the photo voltaic cells 180. Two different designs are contemplated for the first and second sections being releasably detachable on to the bottom rail and photo voltaic cells, respectively. One design comprises channels, tracks, or grooves complementary in shape and size to be clipped/snapped/slid on to the respective bottom rail and photo voltaic cells. An alternative design calls for a complementary shape bracket or clip to be substituted for the channels, tracks, or grooves for clipping the first and second sections of the mounting bracket onto the complementary shape respective bottom rail and photo voltaic cells. FIGS. 10A-10D depict several exemplary designs and views of the channel, track, or groove configured releasably detachable mounting device. That is, FIGS. 10A & 10B show respective perspective and end views of the releasably detachable mounting device 205 with longitudinal channels/tracks or grooves associated with each of the first section 207 and second section 208 for receiving therein the respective bottom rail 110 and photo voltaic cells 180. In this design, the second section 208 is tilted or angled upwards towards the top of the window being covered (the sky). That is, the angle between the first and second sections 207, 208 is an acute angle. FIG. 10F depicts the bottom rail 110 secured in the first section 207 and the photo voltaic cells 180 secured in the second section 208 of the releasably detachable mounting device 205 of FIGS. 10A & 10B. FIGS. 10C & 10D depict perspective and end views of another design of the releasably detachable mounting device 205 with longitudinal channels/tracks or grooves associated with each of the first section 207 and second section 208 for receiving therein the respective bottom rail 110 and photo voltaic cells 180. In this design, the second section 208 is substantially parallel with the plane of the window covering. That is, the first and second sections 207, 208 are substantially perpendicular to one another. Instead of a longitudinal channel/groove/track each of the first and second sections of the releasably detachable mounting device may be configured as a bracket to be clipped or snapped onto the bottom rail and photo voltaic cells, respectively, as represented in FIG. 10E.

Regardless of the configuration of the releasably detachable mounting device (e.g., channel, track, or groove; bracket or clip), the first and second sections may be arranged substantially perpendicular to one another (FIGS. 10C & 10D) or at an acute angle (FIGS. 10A, 10B, 10E & 10F) relative to that of the bottom rail when the window covering is mounted/hung on the window. Orientation of the first and second sections substantially perpendicular to one another promotes compactness, whereas arrangement of these sections at an acute angle relative to one another maximizes insolation. Accordingly, the photo voltaic cells of the present inventive motorized window covering may be disposed at a location and orientation on the bottom rail that optimizes insolation. In comparison, conventional motorized window covering configured with the solar cell located at the head rail are often undesirably shaded by eaves or by window frame members minimizing the amount of sunlight projected onto the photo voltaic cells.

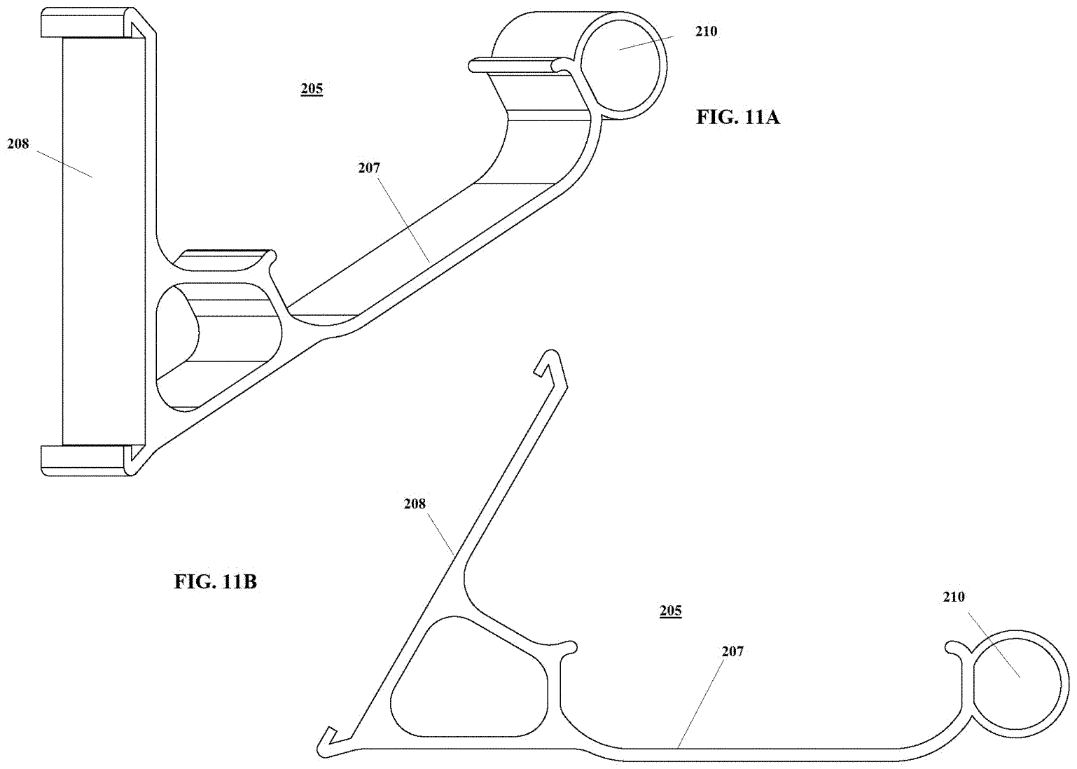

A related problem addressed in the present inventive motorized window covering is the unbalanced load imposed by mounting the photo voltaic cells on the rear/outward-facing surface (i.e., surface facing the window) of the bottom rail 110 resulting in undesirable unevenness (not level) of the bottom rail 110 towards the photo voltaic cells 180. With the goal of maintaining the bottom rail 110 substantially level, a counterweight 210 may be provided to oppose the weight of the photo voltaic cells 180, as shown in FIGS. 11A & 11B. The counterweight 210 may be provided during the extrusion molding process (i.e., increased weight provided on that side of the first section 207 receiving the bottom rail opposite that of the arrangement of the photo voltaic cells). Counterweight 210 is provided externally of the first section 207 in FIGS. 11A & 11B, however, it is possible to locate the counterweight internally within the first section 207 but once again opposite the positioning of the photo voltaic cells. The counterweight may be a single component extending longitudinally or multiple components separated from one another in a longitudinal direction along the channel, groove or track. One or more counterweight(s) may alternatively be disposed on the end cap on the side of the bottom rail opposite that of the placement of the photo voltaic cells. The mass, length, and number of counterweights is dependent on the number (overall dimensions) of the photo voltaic cells attached to the bottom rail of the motorized window covering. Assuming that the number (overall dimensions) of the photo voltaic cells employed remains constant, regardless of the overall shade width the counterbalancing force to maintain the bottom rail substantially level remains the same.

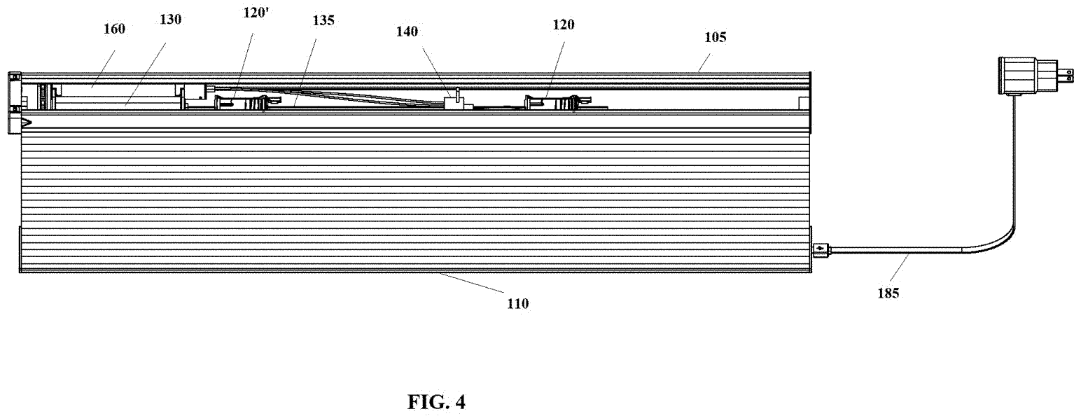

The present inventive motorized window covering also addresses specific features associated with the mechanical/electrical components disposed in the head rail 105. One specific feature is the location of the one or more slip ring(s) 140, 140′ disposed internally within the head rail. In one embodiment a solid (non-through hole) slip ring 140 is disposed proximate one terminating free end (left or right) of the axle rod, outward of the lifting spool 120, as in FIG. 13B or 13C. Otherwise, one or more through-hole type slip ring(s) 140 may be supported on the axle lifting rod between two lifting spools 120, 120′, as shown in FIGS. 3-5, 8, 12 & 13A.

Regardless of the particular features or embodiment, the power storage device 160 of the present inventive motorized window covering is associated with or located at the head rail 105. That is, the power storage device 160 may be mounted interiorly within or exteriorly to the housing of the head rail 105. FIGS. 3, 4, 5 & 13A show the power storage device 160 mounted interiorly within the housing of the head rail 105 to one terminating free end (left or right) of the axle rod 135 (outside the lifting spools). Internally within the head rail, the power storage device 160 need not necessarily by supported by the axle rod 135, but instead mounted directly to the interior surface of the housing of the head rail. FIGS. 13B & 13C, show front and rear views, respectively, of an alternative arrangement with the power storage device 106 mounted to the exterior surface of the housing of the head rail 105. It is also conceivable to mount to the wall, window, or surrounding trim of the window to be covered the power storage device 160 at a height substantially aligned with the head rail 105 of the window covering when installed on the window to be covered, as shown in FIG. 13D. Thus, the power storage device is associated with the head rail (i.e., internally mounted within the headrail, externally mounted to the housing of the headrail, or mounted to the window itself at approximately the same height as the mounted headrail).

Energized by the power storage device 160, motor 130 rotates the axle rod 135 winding the one or more lifting cords 190, 190′ about the associated lifting spools 120, 120′ raising the position of the window covering 115 while the slack in the electrical conductor(s) 145, 145′ is taken-up about the lifting spools 120, 120′ housed in the head rail 110. Despite such movement, the electrical conductors 145, 145′ remain electrically connected to the bottom rail 110 at all times. In the embodiment illustrated in FIGS. 7C, 12 & 14B, lifting cords 190, 190′ may be employed with each of the electrical conductors 145, 145′ incorporated (e.g., braided or twisted) therewith. Alternatively, in FIGS. 10F, 13A-13C & 14A the electrical conductors 145, 145′ pass through the window covering 115 via a route separate and distinct from that of the lifting cord 190. While still another possible design eliminates the lifting cords altogether, replaced by the electrical conductors (e.g., electrical wires) inconspicuously routed through the accordion shade between the head and bottom rails.

During operation, control and programming of movement of the present inventive motorized window covering is controlled by a remote control device 200 (FIG. 1). Buttons on the remote control device control movement of the window covering (e.g., raise or lower typically in predefined increments by depressing respective up and down arrows) to a desired position upon release of the button. Preferably, the holding down of the up or down arrow button for an extended period of time will fully raise/lower the window covering without having to hold the button.

The present inventive motorized window covering is powered by the power storage device 160 (e.g., rechargeable battery) housed in the head rail 105. At any position of the bottom rail, the power storage device 160 is rechargeable by way of: (i) an electric power cable 185 electrically connectable between an electrical socket and the electronic port 150 preferably projecting from the end cap 175 of the bottom rail 110; and/or (ii) photo voltaic cells 180 releasably detachable to the bottom rail 110 and electrically connectable to the electronic port 150 in the end cap 175 of the bottom rail 110. As a result of the electronic port 150 being associated with the bottom rail 110, the power storage device 160 is easily reachable by lowering the position of the bottom rail relative to the head rail without having to use a ladder, stool or chair while simultaneously reducing the safety risk associated with electrical cable running to the head rail in conventional motorized window shades having the electronic port housed in the head rail. Despite the electronic port being associated with the bottom rail in the present inventive motorized window covering, as a failsafe or backup a supplemental electronic port may also be associated with the head rail. Advantageously the electronic port associated with the bottom rail in accordance with the present inventive motorized window covering assembly does not require engagement with a charging dock mounted on the window sill and thus may be charged regardless of the position of the bottom rail relative to that of the head rail.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

Every issued patent, pending patent application, publication, journal article, book or any other reference cited herein is each incorporated by reference in their entirety.

1. A motorized window covering assembly comprising:
a head rail;
a bottom rail;
a window covering extending from the head rail to the bottom rail;
a power storage device located at the head rail;
an electronic port located at the bottom rail; and
electrical conductors routed through the window covering electrically connecting the power storage device to the electronic port;
wherein the power storage device is chargeable at any position of the bottom rail relative to the head rail, and
wherein the power storage device and the electronic port are coupled via a continuous electrical conductive path that includes the electrical conductors such that the power storage device is directly chargeable from the electronic port.

2. The motorized window covering assembly of claim 1, wherein the power storage device is mounted: (i) interiorly to the head rail; (ii) exteriorly to the head rail; or (iii) separately from and substantially aligned with the head rail.

3. The motorized window covering assembly of claim 1, wherein the electrical conductors are routed through the window covering between the head and bottom rails: (i) along a common path braided or twisted with that of a lifting cord; (ii) along a dedicated path separate from a lifting cord; or (iii) the electrical conductors themselves serve as a lifting cord.

4. The motorized window covering assembly of claim 3, wherein: (i) the window covering comprises layers of material forming a shade and the electrical conductors are disposed between the layers of material; or (ii) the window covering comprises a plurality of slats forming a blind and the electrical conductors are woven between or through the plurality of slats.

5. The motorized window covering assembly of claim 1, wherein the electrical conductors are first electrical conductors, and wherein the head rail has mounted therein:
a motor;
an axle rod rotated by the motor;
at least two lifting spools mounted to the axle rod;
a slip ring supported by the axle rod; and
second electrical conductors that are connected, at a lifting spool of the at least two lifting spools, to one or more of the first electrical connectors, are routed via the slip ring, and are connected to the power storage device.

6. The motorized window covering assembly of claim 1, further comprising at least one photo voltaic cell detachably mounted to the bottom rail so as to be camouflaged by the window covering while maximizing insolation, wherein the at least one photo voltaic cell is electrically coupleable to the power storage device by connecting a set of electrical conductors of the at least one photo voltaic cell to the electronic port.

7. The motorized window covering assembly of claim 6, wherein the at least one photo voltaic cell is detachably mounted to the bottom rail by a mounting device including: a first section complementary in dimension and shape to the bottom rail receivable therein; and a second section complementary in dimension and shape to the at least one photo voltaic cells receivable therein.

8. The motorized window covering assembly of claim 7, wherein the first section is a first longitudinal channel or first clip; and the second section is a second longitudinal channel or second clip.

9. The motorized window covering assembly of claim 7, wherein the second section is arranged substantially perpendicular to or tilted at an acute angle relative to the first section.

10. The motorized window covering assembly of claim 1, wherein the electronic port projects from an end cap that is secured to the bottom rail.

11. A method for operating a motorized window covering assembly, the method comprising the step of:
charging, via an electronic port of the motorized window covering assembly, a power storage device of the motorized window covering assembly at any position of a bottom rail of the motorized window covering assembly relative to a head rail of the motorized window covering assembly, the motorized window covering assembly comprising a window covering extending from the head rail to the bottom rail and electrical conductors routed through the window covering electrically connecting the power storage device to the electronic port, wherein the power storage device and the electronic port are coupled via a continuous electrical conductive path that includes the electrical conductors such that the power storage device is directly chargeable from the electronic port.

12. The method of claim 11, wherein the power storage device is mounted: (i) interiorly to the head rail; (ii) exteriorly to the head rail; or (iii) separately from and substantially aligned with the head rail.

13. The method of claim 11, wherein the electrical conductors are routed through the window covering between the head and bottom rails: (i) along a common path braided or twisted with that of a lifting cord; (ii) along a dedicated path separate from a lifting cord; or (iii) the electrical conductors themselves serve as a lifting cord.

14. The method of claim 13, wherein: (i) the window covering comprises layers of material forming a shade and the electrical conductors are disposed between the layers of material; or (ii) the window covering comprises a plurality of slats forming a blind and the electrical conductors are woven between or through the plurality of slats.

15. The method of claim 11, wherein the head rail has mounted therein:
a motor;
an axle rod rotated by the motor;
at least two lifting spools mounted to the axle rod; and
a slip ring supported by the axle rod.

16. The method of claim 11, wherein the motorized window covering assembly further comprises at least one photo voltaic cell detachably mounted to the bottom rail so as to be camouflaged by the window covering while maximizing insolation.

17. The method of claim 16, wherein the at least one photo voltaic cell is detachably mounted to the bottom rail by a mounting device including: a first section complementary in dimension and shape to the bottom rail receivable therein; and a second section complementary in dimension and shape to at least one the photo voltaic cells receivable therein.

18. The method of claim 17, wherein the first section is a first longitudinal channel or first clip; and the second section is a second longitudinal channel or second clip.

19. The method of claim 17, wherein the second section is arranged substantially perpendicular to or tilted at an acute angle relative to the first section.

20. The method of claim 11, wherein the electronic port transferring power and/or data projects from an end cap secured to the bottom rail.

21. The method of claim 11, wherein while charging the power storage device, the bottom rail remains stationary in position.
